(19) United States
(12) Patent Application Publication
(10) Pub. No.: US 2007/0156507 A1
(43) Pub. Date: Jul. 5, 2007

(54) System and methods for identifying talent

(75) Inventors: Joseph George Connelly, Sparta, NJ (US); Bonnie Elaine Kraus, Sparta, NJ (US)

Correspondence Address: LAW OFFICES OF RITA C. CHIPPERSON, 89 HEADQUARTERS PLAZA NORTH, 14TH FLOOR, SUITE 1472, MORRISTOWN, NJ, 07960, US

(73) Assignee: Two Suns, LLC

(21) Appl. No.: 11/326,173

(22) Filed: Jan. 4, 2006

(51) Int. Cl. G06F 17/30

(52) U.S. Cl. 705/10; 705/11

(57) ABSTRACT

Disclosed are systems and methods for identifying talent via local, national, or worldwide talent competitions, which eliminate or minimize the costs and/or risks of identifying such talent and generate significant charitable donations. In one aspect of the present invention, artists' or bands' songs are made available to critics such as members of the public via mediums such as the Internet, radio, and television. Such individuals provide feedback during successive phases of the talent identification process, and artists and/or bands with the greatest public appeal advance to the final stages of the process. Ultimately, the artist or band receiving the most favorable feedback is awarded with, for example, a record deal. Throughout the process, revenue is generated via a variety of methods including voting/critiquing fees, advertising, promotional items, and the like. In some aspects of the present invention, at least a portion of such revenue is donated to charity.

### BACKGROUND OF THE INVENTION

Embodiments of the present invention generally relate to systems and methods for identifying talent. More specifically, the present invention relates to systems and methods for identifying talent via global talent competitions, which eliminate or minimize the costs and/or risks of identifying such talent and include mechanisms for generating significant charitable donations.

The music industry is dominated by four major record labels, which control approximately 70% of the worldwide music market and approximately 85% of the United States music market. These record labels include Universal Music Group with approximately 25.5% of the worldwide music market, Sony BMG Music Entertainment with approximately 21.5% of the worldwide music market, EMI Group with approximately 13.4% of the worldwide music market, and Warner Music Group with approximately 11.3% of the worldwide music market. Consequently, these four record labels are responsible for the discovery and promotion of the majority of aspiring new artists.

Currently, these record labels incorporate a variety of techniques to evaluate thousands of new artists daily in search of those artists whose promotion will create a substantial return on investment for the record label. Such techniques include the employment of highly paid talent scouts, who are tasked with evaluating and discovering the next great talent. Many talent scouts seek artists who possess a significant preexisting fan base or other indicators of success, thereby increasing the likelihood that promotion of such artist will result in a solid return on investment for the record label. Since every selected artist incurs substantial upfront promotion costs prior to generation of revenue for the record label, the record label faces financial loss whenever a promoted artist does not provide the anticipated return on investment.

Entities other than record labels have also implemented systems and methods for identifying talent. One such method includes regional talent competitions (e.g., battle of the band competitions), in which bands compete against each other in live performances at designated venues. In such competitions, the bands are typically screened and selected prior to the competition by personnel associated with the competition such as a judge, panel of judges, talent scout, or the like. These competitions are typically organized and/or conducted by private entities to generate revenue from ticket sales, concessions, merchandising, and the like.

Similarly, worldwide Internet talent competitions exist. In one such system, artists may upload their songs to a talent competition Web site for a fee, and industry experts employed by the Internet talent competition evaluate the uploaded songs. In such competitions, the industry experts screen potential contestants for the Internet talent competition prior to the competition. Such experts typically select the artists that will be allowed to compete in the talent competition. Thereafter, the public is exposed to the selected artists via the Internet medium and may provide feedback for the selected artists via the talent competition Web site. Such competitions are typically organized and/or conducted by private entities to generate revenue from the fees paid by the initial contestants.

Moreover, televised talent competitions such as American Idol and the like exist. American Idol personnel hold auditions in cities across the United States for thousands of artists during which the pool of artists is judged and narrowed to a predetermined quantity. The selected artists then perform in weekly competitions before a live studio audience on broadcast television. A panel of industry expert judges evaluates each artist during every level of competition, however, the final winner of the competition is decided by public vote. The American Idol competition is organized and/or conducted by private entities to generate revenue from sources such as television advertising, merchandising, and the like.

### BRIEF SUMMARY OF THE INVENTION

Briefly stated, in one aspect of the present invention, a method of identifying talent is provided. This method includes receiving talent from at least one competition not affiliated with a user of the method, receiving media from the talent, making at least one of the group consisting of the talent, the media, and combinations thereof available to the public via a first medium, receiving feedback from the public, selecting a portion of the talent based upon the feedback, making at least one of the group consisting of the talent, the media, and combinations thereof available to the public via a second medium, receiving feedback from the public, selecting a portion of the talent based upon the feedback, making at least one of the group consisting of the talent, the media, and combinations thereof available to the public via a third medium, receiving feedback from the public, selecting at least one top performer based upon the feedback, wherein the talent is at least one of the group consisting of individual artists, groups of artists, bands, and combinations thereof, and wherein the media is at least one of the group consisting of songs, videos, and combinations thereof

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown. In the drawings:

FIG. 1 depicts the phases of one method of identifying talent in accordance with one embodiment of the present invention;

FIG. 2 depicts the phases of an alternate method of identifying talent in accordance with an embodiment of the present invention;

FIG. 3 depicts the phases of yet another method of identifying talent in accordance with an embodiment of the present invention;

FIGS. 4A-4C depict a flowchart of one method for identifying talent in accordance with one embodiment of the present invention; and

FIG. 5 depicts a diagram of an exemplary computer environment for use with the systems and methods of identifying talent in accordance with an embodiment of the present invention.

### DETAILED DESCRIPTION OF THE INVENTION

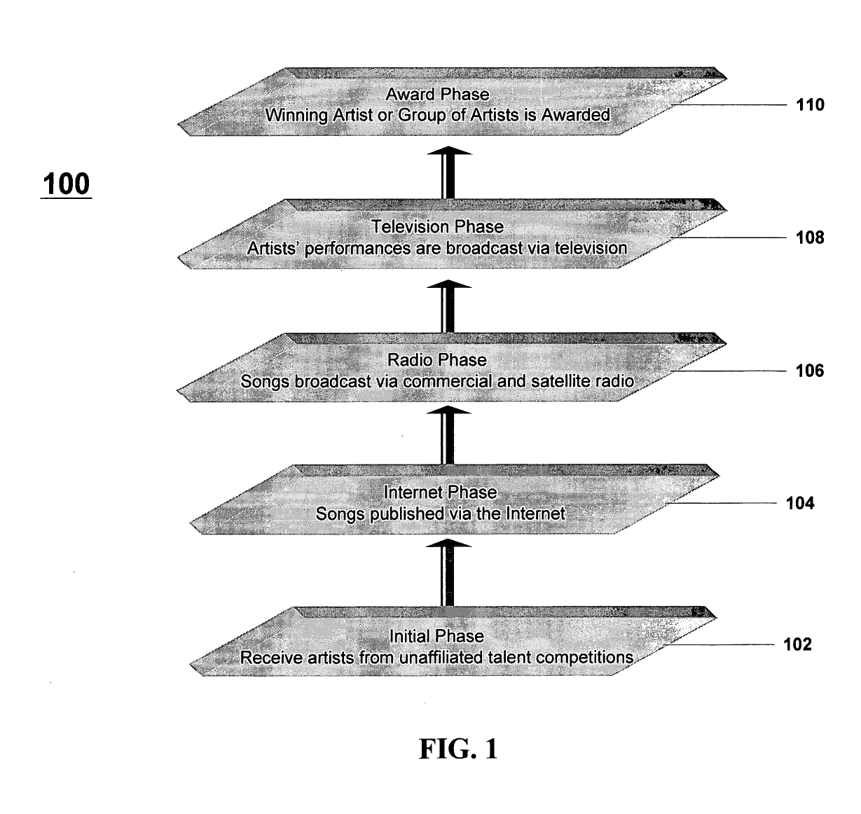

Referring first to FIG. 1, illustrated are five phases of an exemplary embodiment of a system and method for identifying talent. In the depicted embodiment, artists or a group of artists (e.g., a band) selected from a plurality of existing talent competitions are exposed to critics such as members of the public via mediums such as the Internet, radio, and television. Critique, feedback, and the like are gathered at each phase of the system and method to determine which artists and/or bands shall be exposed to the scrutiny of the critics via each of the distinct mediums. Furthermore, such critique, feedback, scrutiny, and the like shall ultimately determine which of the competing artists and/or bands shall be rewarded at the conclusion of the contest with, for example, a recording contract.

Talent identification process 100 begins at initial phase 102. In one aspect of the present invention, initial phase 102 includes receiving artists and/or bands from one or more existing local talent competitions. Such talent competitions may include existing battle of the band competitions and/or various other talent competitions conducted worldwide. Such competitions may be conducted live or via mediums such as the Internet, radio, television, and the like. Furthermore, the contestants of such competitions may include individual artists, groups of artists, bands, or the like.

In one aspect of the present invention, a set of existing local talent competitions from which talent shall be advanced to Internet phase 104 is selected. Preferably, such set of competitions is selected to ensure worldwide participation in the systems and/or methods of the present invention to increase the likelihood of identifying a “Super Group” or “Super Artist” having worldwide appeal. For example, such set of existing local talent competitions may include one competition per participating country. Or such set may include one competition for each smaller participating country and one competition per state, or other geographical subdivision, for each larger participating country. Virtually any combination of local talent competitions may be implemented via the systems and

methods of the present invention. However, the systems and methods of the present invention are not limited to worldwide competition. Such systems and methods may be incorporated for identification of talent from a talent pool selected from a smaller geographic area (e.g., the United States, the State of New York, etc.) without departing from the scope hereof.

After a set of existing local talent competitions from which performers, artists and/or bands shall be advanced to Internet phase 104 is selected, criteria shall be defined to determine which artists and/or bands from each local talent competition shall be advanced. For example, in one embodiment of the present invention, only one winner from each of the predetermined list of local talent competitions shall be advanced to Internet phase 104. However, in other embodiments of the present invention, all finalists and/or all semi-finalists from each individual talent competition may be advanced to Internet phase 104. However, the present invention is not so limited. Virtually any criteria for determining which artists and/or bands from each local talent competition will be advanced to Internet phase 104 may be implemented without departing from the scope hereof.

Receiving artists and/or bands from initial phase 102 and advancement of such artist and/or band through talent identification process 100 via the systems and methods of the present invention provides a variety of benefits and advantages. In one aspect of the present invention, initial phase 102 eliminates or reduces the overhead of the entity seeking to identify talent by allowing the initial talent pool to be selected purely via a plurality of existing local talent competitions. Once a group of local talent competitions has been selected (e.g., one talent competition per state, one talent competition per country, etc.) and the criteria for selecting talent from each of the local talent competitions has been determined (e.g., each winner of each competition will be advanced to Internet phase 104), advancement of such participants in the systems and methods of the present invention is purely administrative. That is, the need for highly paid talent assessment personnel is completely eliminated since the local talent competitions determine the winners for each competition independent of the entity implementing the systems and methods of the present invention.

Also, receiving artists and/or bands selected by the systems and methods of the local talent competitions increases the likelihood that the artist and/or band selected by the systems and methods of the present invention (e.g., public preferences, music listener preferences, etc.) will become “The Next Great Super Group” or “The Next Great Super Artist”. In many instances, such artists and/or bands are selected in the local talent competitions purely based upon the public's vote, or the votes of those in attendance at the local talent competition. Since such voters and/or attendees tend to comprise a large portion of music consumers, their opinions regarding the quality of up and coming artists and/or bands are more likely to reflect those of the music consumer. Allowing a plurality of actual music consumers, rather than an individual, highly paid recording industry talent scout, to select the initial talent pool increases the possibility that the artist and/or band selected using the systems and methods of the present invention will be more palatable to music consumers as a whole, thereby increasing the likelihood that the identified talent will become the “The Next Great Super Group” or “The Next Great Super Artist”.

Furthermore, the aforementioned increase in the likelihood of finding the “The Next Great Super Group” or “The Next Great Super Artist” minimizes the risk and maximizes the return on investment of the entity implementing the systems and methods of the present invention (e.g., a record label). As the successful artists and/or bands advance through each phase of talent identification process 100, global fan support for and marketability of each artist and/or band is proven. Similarly, at the conclusion of talent identification process 100, the successful artist and/or band has proven his, her, or their marketability, which minimizes the risk associated with investing financial capital into further promotion of such successful artist and/or band. Furthermore, since marketability and fan support have already been proven, it is more likely that the entity implementing the systems and methods of the present invention will maximize its return (e.g., profits from song sales, concert sales, and the like) on funds invested in the further promotion of such artist and/or band.

In addition, the systems and methods of the present invention (including the step of receiving artists and/or bands from initial phase 102) provide all artists and/or bands with equal opportunity and equal access to the entity implementing the systems and methods of the present invention by eliminating the bias, favoritism, bad judgment, and the like of such entity, which can result in the promotion of mediocre or untalented artists and/or bands. Via the present invention, absolutely every artist and/or band from around the world has the opportunity to enter an existing local talent competition. Thereafter, if successful, such artists and/or band may advance through talent identification process 100 unimpeded by any employee of the entity implementing the present invention. That is, such artist and/or band advances purely on his, her, or their skill, talent, and acceptance by the general participating listening public.

Also, some implementations of the systems and methods of the present invention result in a truly unbiased worldwide identification of talent since cultural biases are minimized and/or eliminated. The advancement of artists and/or bands from initial phase 102 to Internet phase 104 is determined solely by the local talent competition audiences and/or judges. Typically, such audiences and/or judges are from the same culture as the competing artists and/or bands. Consequently, the methods of advancing artists and/or bands of the present invention minimize the possibility that artists and/or bands will be eliminated due to cultural biases or differences. For example, a New York City record label executive may be unintentionally, or intentionally, biased toward selection of United States artists and/or bands due to such executive's familiarity with the United States culture. Such bias may result in non-recognition of “The Next Great Super Group” or “The Next Great Super Artist” solely due to such cultural bias. When implemented in a worldwide embodiment, the systems and methods of the present invention minimize or eliminate the possibility of such non-recognition. Furthermore, the voting public's exposure to culturally diverse musical talent and styles will likely create new markets for such music in areas that may not have been previously exposed to them due to the cultural and/or artificial music industry walls or boundaries.

Moreover, some embodiments of the systems and methods of the present invention facilitate identification of a truly global talent pool by geographically segmenting one or more of initial phase 102, Internet phase 104, and radio phase 106. Such segmentation narrows the talent pool to be critiqued by each critic. If such segmentation were not implemented, each critic would be tasked with critiquing each and every one of the artists and/or bands participating in the first phase of the global talent identification process 100. Such a cumbersome and time-consuming critiquing process is likely to minimize the quantity of individuals willing to partake in such critiquing, thereby minimizing the effectiveness of the entire talent identification process 100. Consequently, the systems and methods of the present invention act to segment, and thereby limit the number of, artists and/or bands to be critiqued by each pool of critics to facilitate such process, thereby maximizing the effectiveness of the entire talent identification process 100.

Segmentation of one or more phases of talent identification process 100 facilitates worldwide participation in the final phases (e.g., television phase 108) oftalent identification process 100. Since critics provide critique, feedback, and the like during the early stages of talent identification process 100, many such individuals will develop an interest or desire to continue such critiquing throughout the entire process. In some instances, such individuals may develop artist and/or band loyalty and may wish to help their favorite artists and/or bands achieve the ultimate prize. Such desire to participate and artist and/or band loyalty will encourage individuals from around the globe to continue participating in talent identification process 100 through the completion of the process, even if such completion involves a single television broadcast or a single series of television broadcasts. Inclusion of such critics at the onset of talent identification process 100 maximizes the possibility that such individuals will tune in for the final stage(s), thereby increasing the overall effectiveness of talent identification process 100.

The popularity and widespread, or worldwide, participation in talent identification process 100 further operates to encourage and/or attract new artists and/or bands, and potentially highly talented artists and/or bands, to participate in each subsequent implementation of the talent identification process 100. Such encouragement and/or attraction are likely to provide a continuous flow of talented artists and/or bands for every subsequent implementation of the present invention, thereby increasing the quality of the process and, presumably, the quality of the rewarded artist and/or band. Such increase in quality further increases the likelihood of finding the “The Next Great Super Group” or “The Next Great Super Artist”.

For all of the aforementioned reasons, talent identification process 100 begins with an initial phase such as that described for initial phase 102. After completion of initial phase 102, talent identification process 100 proceeds to Internet phase 104.

At Internet phase 104, songs and/or music videos are received from the artists and/or band who have met the required criteria for advancement from initial phase 102 to Internet phase 104 (i.e., the “advancing artists and/or bands”). In one aspect of the present invention, such received songs are original works that have been created and performed by the respective artist(s) and/or band(s). However, alternate embodiments of the present invention are envisioned in which such received songs have been created by entities other than the advancing artist(s) and/or band(s). Or, such received songs may be songs originally performed by artist(s) and/or band(s) other than the advancing artist and/or band.

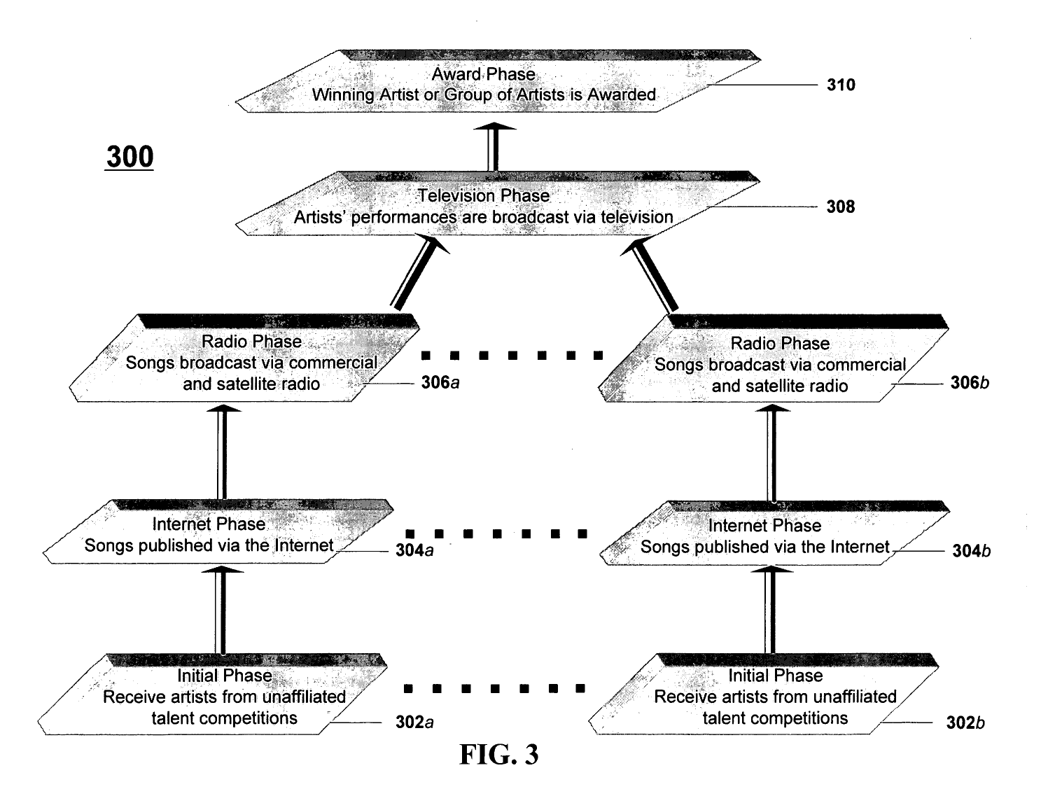

After receipt of songs and/or music videos from the advancing artists and/or bands, such songs and/or music videos are then published via a computer network such as the Internet or the like via creation of user interfaces such as Web pages. Such publication allows critics to provide critique, feedback, and the like for each of the published songs and/or music videos. In one embodiment of the present invention, critics vote for each song and/or music video. In another embodiment of the present invention, a system such as that described with respect to FIG. 3 below, tallies the number of times each song and/or music video is accessed by a critic. Or, alternatively, such a system may tally the number of times each song is downloaded. Virtually any method of quantifying the acceptance or popularity of a particular song and/or music video by critics, such as members of the public, may be substituted without departing from the scope of the present invention.

In some aspects of the present invention, critics are charged fees for providing such critique, feedback, or the like. Such fees may include fees for casting a vote, fees for downloading a song, fees for listening to a song, fees for viewing a music video, fees for purchasing an artist or band's product, and the like.

Furthermore, embodiments of the present invention are envisioned in which revenue is also derived from advertising and sponsorship of Web sites, Web pages, and the like associated with talent identification process 100. In addition, revenue may be generated from sale of products associated with talent identification process 100 such as clothing, hats, mugs, bumper stickers, and the like. The interaction between the critics and the talent identification process 100 creates opportunities for future direct marketing of goods and services to the critic. Moreover, demographic information may be collected prior to allowing a critic to provide feedback, and such information may be utilized to increase advertising sales for future implementations of talent identification process 100.

In some embodiments of the present invention, at least a portion of charged fees or other collected revenue is donated to a charity such as those charities that support the interests of starving artists and/or bands. However, such portions of charged fees or other collected revenue may also be donated to unrelated charities without departing from the scope hereof.

Collection of critique, feedback, and the like will occur during Internet phase 104 for a predetermined period of time. Upon the expiration of such time period, the artists and/or bands whose songs have received the most favorable feedback (e.g., the highest number of votes, the highest number of downloaded or accessed songs, etc.) will advance to the next phase of talent identification process 100 (e.g., radio phase 106).

In radio phase 106, songs received from the artists and/or bands that advanced from Internet phase 104 to radio phase 106 will be broadcast via radio such as commercial radio, satellite radio, and the like. In some embodiments of the present invention, such songs shall be the same songs evaluated during earlier phases of talent identification process 100 (e.g., Internet phase 104). However, alternate embodiments of the present invention are envisioned in which each advancing artist and/or band must submit new songs for evaluation in one or more of the phases (e.g., radio phase 106) following Internet phase 104.

In one embodiment of the present invention, the songs broadcast during radio phase 106 will be broadcast locally and/or internationally via one or more newly created radio stations (e.g., a newly created “Undiscovered Talent Station”), which may be dedicated to discovery of new talent and/or talent identification process 100. In some such embodiments of the present invention, songs from the existing “Super Groups” and “Super Artists” (e.g., the Beatles, Led Zeppelin, etc.) are played in combination with the songs received from the advancing artists and/or bands to provide perspective to the listeners and/or critics and to attract a larger audience of listeners. However, combination of the advancing artists' and/or bands' songs with existing songs, whether such songs are performed by “Super Groups”, “Super Artists”, or other lesser known musicians, may also be implemented in embodiments of the present invention in which the advancing artists' and/or bands' songs are played via non-dedicated radio stations without departing from the scope hereof.

Broadcast of the songs of the advancing artists and/or bands via one or more radio stations encompassing the geographic area of talent identification process 100 (e.g., worldwide) allows critics within such geographic area to listen to, and evaluate, such broadcast songs. Additionally, radio phase 106 attracts new participants to talent identification process 100, such as those individuals who are not computer-savvy. Either during, or at the conclusion of, radio phase 106, such critics shall be provided with the ability to provide critique, feedback, or the like for one or more broadcast songs, artists, and/or bands. Such critique, feedback, or the like may be provided via any system and method known in the art or any systems and methods yet to be invented without departing from the scope of the present invention. Such systems and methods include, but are not limited to, electronic mail, text messaging, telephones, cell phones, Apple Ipods™, personal computers, and Blackberrys®.

In some aspects of the present invention, critics are charged fees for providing such critique, feedback, or the like during radio phase 106. Such fees may include fees for casting a vote. Additional revenue may also be generated for advertising and sponsorship of the radio stations associated with talent identification process 100, as well as the sale of products associated with talent identification process 100. As discussed above with respect to Internet phase 104, in some embodiments of the present invention, at least a portion of charged fees or other collected revenue is donated to charity.

Collection of critique, feedback, and the like will occur during radio phase 106 for a predetermined period of time. Upon the expiration of such time period, the artists and/or bands whose songs have received the most favorable feedback (e.g., the highest number of votes) will advance to the next phase of talent identification process 100 (e.g., television phase 108).

In television phase 108, the artists and/or bands whose songs received the most favorable feedback in radio phase 106 will compete in a local, national, or international television competition. In some embodiments of the present invention, such artists and/or bands shall perform the same song or songs evaluated during earlier phases of talent identification process 100 (e.g., Internet phase 104, radio phase 106, etc.). However, alternate embodiments of the present invention are envisioned in which each advancing artist and/or band must perform a new song for evaluation in television phase 108.

Competition of the advancing artists and/or bands via one or more television shows broadcast to the entire geographic area of talent identification process 100 (e.g., worldwide) allows critics within such geographic area to see, hear, and evaluate such artists and/or bands and the associated performances. Either during, or at the conclusion of, television phase 108, such critics shall be provided with the ability to provide critique, feedback, or the like for one or more of the competing artists and/or bands. Such critique, feedback, or the like may be provided via any system and method known in the art or any systems and methods yet to be invented without departing from the scope of the present invention. Such systems and methods include, but are not limited to, electronic mail, text messaging, telephones, cell phones, Apple Ipods™, personal computers, and Blackberrys®.

Similar to that discussed above with respect to the other phases of talent identification process 100, in some aspects of the present invention, critics are charged fees for providing such critique, feedback, or the like during television phase 108. Such fees may include fees for casting a vote. Additional revenue may also be generated for advertising and sponsorship of the television shows associated with talent identification process 100, as well as the sale of products associated with talent identification process 100. As discussed above with respect to Internet phase 104 and radio phase 106, in some embodiments of the present invention, at least a portion of charged fees or other collected revenue is donated to charity.

Collection of critique, feedback, and the like will occur during television phase 108 for a predetermined period of time. Upon the expiration of such time period, the artist and/or band, who receive the most favorable feedback (e.g., the highest number of votes) will advance to award phase 110.

In one aspect of the present invention, during award phase 110, the artist and/or band receiving the most favorable feedback during the prior phase may be named “The Next Great Super Group” or “The Next Great Super Artist”. In another aspect of the present invention, such artist and/or band advancing to award phase 110 is awarded a record deal. Although only one, or some other minimal quantity of, artists and/or bands will typically be selected as the winner of talent identification process 100, all of the artists and/or bands participating therein will be awarded with worldwide exposure and publicity, which may potentially lead to a record deal or other benefits separate and distinct from talent identification process 100.

In another embodiment of the present invention, talent identification process 100 additionally includes a critic award process. In its most simplistic form, the critic(s) that correctly identify the winner of talent identification process 100 in every phase of such process receives an award. Alternatively, the critic award process may occur during each individual phase of identification process 100. That is, winning critic(s) may be selected at the end of each phase. In one such embodiment, a different critic is selected as a winner of each phase.

In another such embodiment, several critics are selected as critic semi-finalists at the conclusion of initial phase 102. In this embodiment, the critic semi-finalists selected at the conclusion of initial phase 102 proceed to Internet phase 104, at which one or more of the critic semi-finalists are eliminated. This process is repeated at the conclusion of radio phase 106 and television phase 108 until one or more of the critic semi-finalists are determined to be the critic winner. Such winner may then receive an award during award phase 110. Additionally, the critic semi-finalists may receive differing awards based upon the extent to which each semi-finalist critic advances through the critic award portion of talent identification process 100.

In the embodiments of the present invention in which critics are ranked, a method of ranking is required. In one embodiment of the present invention, the method of ranking is based upon how accurately each critic guesses the semi-finalists of each phase of talent identification process 100. Alternatively, the method of ranking may be based upon how well the critic assesses the artist and/or band. This assessment may include, but is not limited to, written critiques of the artist and/or band, verbal critiques of the artist and/or band, knowledge of industry standards relating to the artist and/or bands' performances, and combinations thereof. In addition, such critics may be ranked by professional talent scouts, judges, or the like, or, alternatively, such individuals may be ranked by each other (i.e., the critics tasked with critiquing the artists and/or bands). However, the present invention is not so limited. Virtually any criteria and/or method for ranking critics or selecting a winning critic may be implemented without departing from the scope hereof.

Although the critic winner may receive any award without departing from the scope of the invention, the award may be selected to add to the entertainment value of talent identification process 100. For example, the critic winner may be awarded a position as a talent scout or agent. Or, the critic winner may host a phase of a subsequent implementation of talent identification process 100 (e.g., television phase 108).

Although FIG. 1 depicts the steps of talent identification process 100 in a specific, predetermined manner (i.e., Internet phase 104, radio phase 106, and television phase 108), varying sequences of such steps may be substituted without departing from the scope of the present invention. For example, television phase 108 may precede radio phase 106, radio phase 106 may preceded Internet phase 104, etc. Furthermore, some phases may include combinations of the phases discussed herein. For example, television phase 108 may include an Internet counterpart in which critics may view the television show via the Internet.

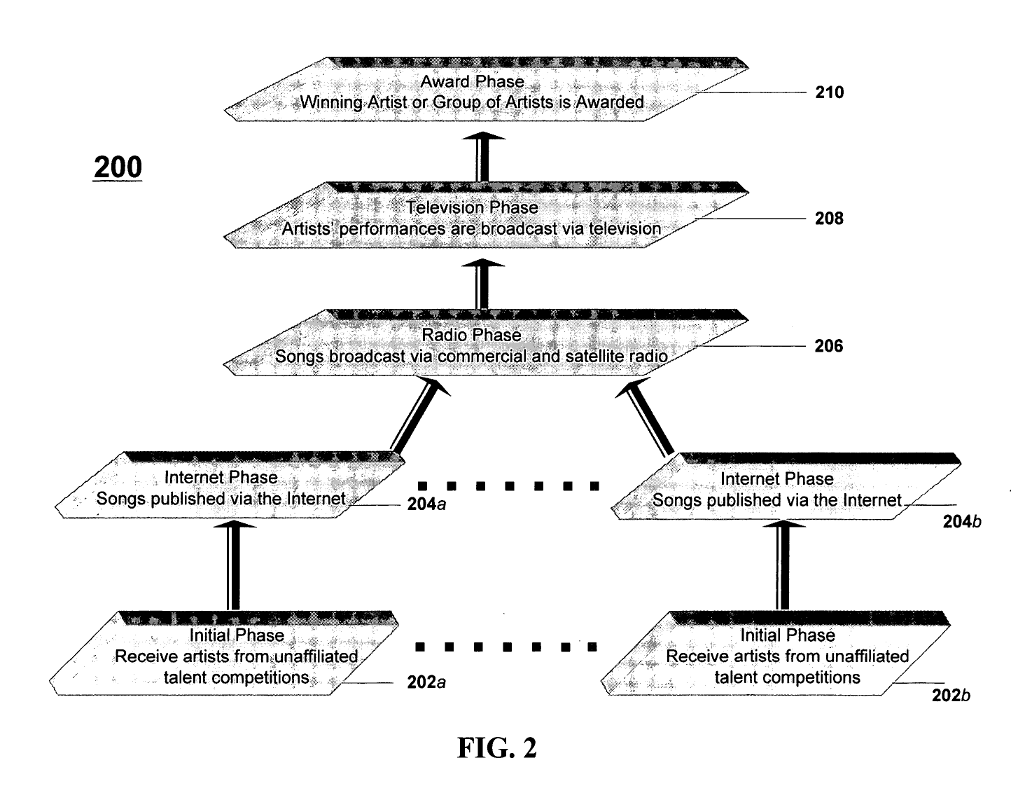

Turning next to FIG. 2, illustrated is another exemplary embodiment of a system and method for identifying talent. In talent identification process 200, radio, television, and award phases 206,208, and 210, respectively, are similar to radio, television, and award phases 106, 108, and 110, respectively, of talent identification process 100 as described above with respect to FIG. 1. However, talent identification process 200 differs from talent identification process 100 with respect to its initial and Internet phases 202 and 204, respectively.

In the embodiment of the present invention depicted in FIG. 2, a plurality of initial phases 202 and Internet phases 204 exist. In one aspect of the present invention, each grouped initial phase 202 and Internet phase 204 (e.g., initial phase 202a and Internet phase 204a) is associated with a subset of the totality of the existing talent competitions selected as a part of the implementation of the present invention. Virtually any criteria may be used for separation of the existing talent competitions into subsets. In one embodiment of the present invention, the existing talent competitions are separated based upon geographic areas. For example, each country participating in talent identification process 200 may have a dedicated initial phase 202 and Internet phase 204. Or, alternatively, the existing talent competitions may be divided based on different genres of music. For example, classic rock, rap, dance, and the like may each comprise a separate and distinct subset. Other possible subsets include, but are not limited to, regions of the world, regions of a country, number of artists in the band, age of the artist and/or band, alphabetic separation of the artist's and/or band's name, alphabetic separation of the artist's and/or band's song name, date of the existing talent competition, time of year of the competition, and combinations thereof. However, any method of separation of the existing talent competitions may be substituted without departing from the scope of the present invention. Additionally, any quantity of initial and Internet phases 202 and 204 may be included without departing from the scope hereof.

As part of each individual Internet phase 204, songs and/or music videos are received from the artists and/or band who have met the required criteria for advancement from the associated initial phase 202 to the respective Internet phase, as described above with respect to FIG. 1. After receipt of songs and/or music videos from the advancing artists and/or bands, such songs and/or music videos are then published via a computer network such as the Internet or the like via creation of user interfaces such as Web pages. In one aspect of the present invention, each Internet phase 204 has a dedicated user interface (e.g., each Internet phase 204 may be associated with a dedicated Web page, a dedicated hypertext link on a single Web Page, a dedicated Web Site, etc.).

Such publication allows critics to provide critique, feedback, and the like for each of the published songs and/or music videos, as described above with respect to FIG. 1. However, in this embodiment of the present invention, the critics may choose to critique the artists and/or bands in any one or more of the multiple subsets (i.e., the multiple Internet phases 204). This allows critics with limited time to participate in talent identification process 200 by reducing the quantity of songs and/or videos that the critic must review prior to providing feedback. Additionally, segmenting initial phase 202 and/or Internet phase 204 minimizes the possibility that the critics will provide feedback without reviewing all published songs and/or videos. For example, a critic who becomes bored or tired of reviewing the published songs and/or videos may provide incorrect or inaccurate feedback due to his or her failure to review all published songs and/or music videos. This may prevent the critic from providing favorable feedback for the best artists and/or bands if such critic failed to review to such artist(s)' and/or bands' published songs or videos. However, a critic may choose to review all songs and/or videos in all Internet phases 204 if so desired by simply accessing each of the user interfaces associated with each of the Internet phases 204. Alternatively, a critic could choose to review all songs and/or videos in all Internet phases 204 while opting to provide feedback for a single Internet phase 204 only. Additionally, incorporation of a plurality of Internet phases 204 allows the critics to review music and/or videos in select subsets only (e.g., a critic may desire to review classic rock songs and/or videos while avoiding review of rap songs and/or videos).

Such embodiments of the present invention also allow a more varied range of semi-finalists to reach the final phases of talent identification process 200. For example, in embodiments of the present invention including a single Internet phase 204, an artist and/or band of one genre or other type of subset may be eliminated if a majority of the critics prefer one specific subset. However, in embodiments of the present invention incorporating multiple Internet phases 204 separated by categories such as music genre, the semi-finalists are guaranteed to represent each of the categories of each of the Internet phases 204.

In yet another embodiment of the present invention, only one initial phase 202 is implemented, however, it leads to several Internet phases 204. That is, the advancing artists and/or bands determined in initial phase 202 may be split between a plurality of Internet phases 204. For example, such advancing artists and/or bands may be sorted into Internet phases 204 based upon predefined criteria such as that discussed above.

Collection of critique, feedback, and the like will occur during each Internet phase 204 for a predetermined period of time. In one embodiment of the present invention, upon the expiration of the respective time period, the artists and/or bands whose songs have received the most favorable feedback in each Internet phase 204 will advance to a single radio phase 206. Alternatively, in another embodiment of the present invention, criteria shall be defined to determine which artists and/or bands from each Internet phase 204 shall be advanced. For example, in one embodiment of the present invention, only one winner from each Internet phase 204 shall be advanced to radio phase 206. However, in other embodiments of the present invention, all finalists and/or all semi-finalists from each Internet phase 204 may be advanced to radio phase 206. However, the present invention is not so limited. Virtually any criteria for determining which artists and/or bands from each Internet phase 204 will be advanced to radio phase 206 may be implemented without departing from the scope hereof.

Referring now to FIG. 3, illustrated is another exemplary embodiment of a system and method for identifying talent. In talent identification process 300, television and award phases 308 and 310, respectively, are similar to television and award phases 108 and 110, respectively, of talent identification process 100 as described above with respect to FIG. 1. Also, initial and Internet phases 302 and 304, respectively, are similar to initial and Internet phases 202 and 204, respectively, of talent. identification process 200 as described above with respect to FIG. 2. However, talent identification process 300 differs from talent identification processes 100 and 200 with respect to its radio phase 306.

In the embodiment of the present invention depicted in FIG. 3, a plurality of radio phases 306 exist. In one aspect of the present invention, each radio phase 306 is grouped with an initial phase 302 and Internet phase 304 (e.g., initial phase 302a and Internet phase 304a), and each three phase grouping is associated with a subset of the totality of the existing talent competitions selected as a part of the implementation of the present invention. Virtually any criteria may be used for separation of the existing talent competitions into subsets as described above with respect to FIG. 2.

As part of each individual radio phase 306, songs are received from the artists and/or bands who have met the required criteria for advancement from the associated Internet phase 304 to the respective radio phase 306, as described above with respect to FIG. 1. Such songs will be broadcast via radio such as commercial radio, satellite radio, and the like, as described above with respect to FIG. 1. In one aspect of the present invention, each radio phase 306 has a dedicated radio station.

Such broadcast allows critics to provide critique, feedback, and the like for each of the broadcast songs, as described above with respect to FIG. 1. However, in this embodiment of the present invention, the critics may choose to critique the artists and/or bands in any one or more of the multiple subsets (i.e., the multiple radio phases 306). This allows critics with limited time to participate in talent identification process 300 by reducing the quantity of songs that the critic must listen to prior to providing feedback. Additionally, segmenting radio phase 306 minimizes the possibility that the critics will provide feedback without listening to all broadcast songs. For example, a critic who becomes bored or tired of listening to the broadcast songs may provide incorrect or inaccurate feedback due to his or her failure to listen to all broadcast songs. This may prevent the critic from providing favorable feedback for the best artists and/or bands if such critic failed to listen to such artist(s)' and/or bands' broadcast songs. However, a critic may choose to listen to all songs in all radio phases 306 if so desired by simply accessing each of the radio phases (e.g., accessing each of the radio stations). Alternatively, a critic could choose to listen to all songs in all radio phases 306 while opting to provide feedback for a single radio phase 306 only. Additionally, incorporation of a plurality of radio phases 306 allows the critics to listen to all songs in select subsets only (e.g., a critic may desire to listen to classic rock songs while avoiding listening to rap songs).

Such embodiments of the present invention also allow a more varied range of semi-finalists to reach the final phases of talent identification process 300. For example, in embodiments of the present invention including a single radio phase 306, an artist and/or band of one genre or other type of subset may be eliminated if a majority of the critics prefer one specific subset. However, in embodiments of the present invention incorporating multiple radio phases 306 separated by categories such as music genre, the semi-finalists are guaranteed to represent each of the categories of each of the radio phases 306.

In yet another embodiment of the present invention, only one initial phase 302 and/or Internet phase 304 is implemented, however, it leads to several radio phases 306. That is, the advancing artists and/or bands determined in initial phase 302 and/or Internet phase 304 may be split between a plurality of radio phases 306. For example, such advancing artists and/or bands may be sorted into radio phases 306 based upon predefined criteria such as that discussed above.

Collection of critique, feedback, and the like will occur during each radio phase 306 for a predetermined period of time. In one embodiment of the present invention, upon the expiration of the respective time period, the artists and/or bands whose songs have received the most favorable feedback in each radio phase 306 will advance to a single television phase 308. Alternatively, in another embodiment of the present invention, criteria shall be defined to determine which artists and/or bands from each radio phase 306 shall be advanced. For example, in one embodiment of the present invention, only one winner from each radio phase 306 shall be advanced to television phase 308. However, in other embodiments of the present invention, all finalists and/or all semi-finalists from each radio phase 306 may be advanced to television phase 308. However, the present invention is not so limited. Virtually any criteria for determining which artists and/or bands from each radio phase 306 will be advanced to television phase 308 may be implemented without departing from the scope hereof.

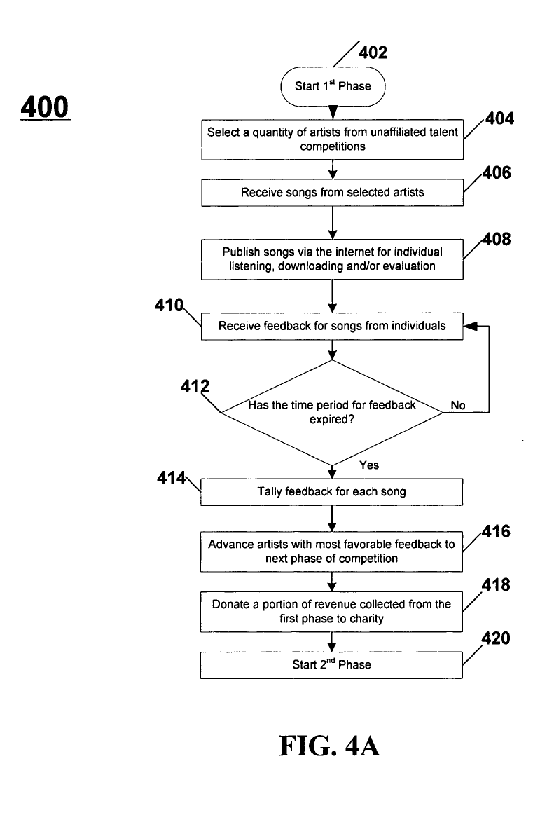

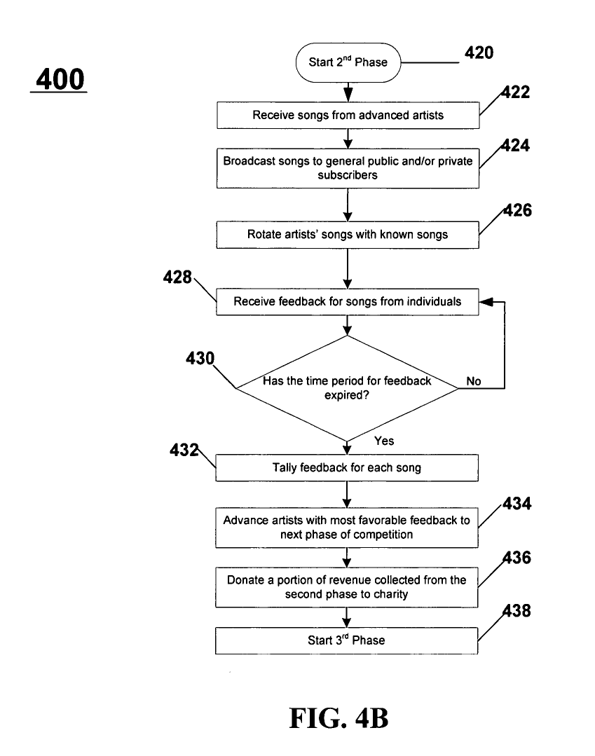

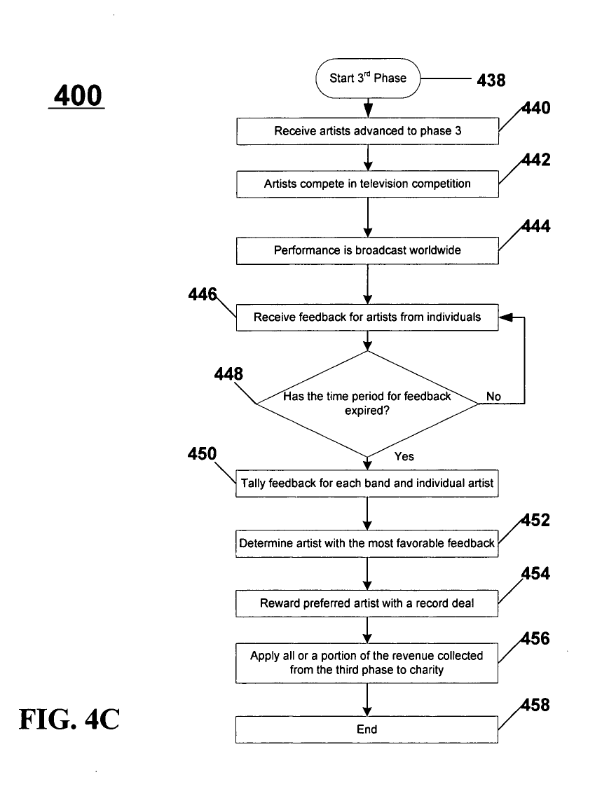

Referring next to FIGS. 4A-4C, illustrated is a flow diagram of an exemplary embodiment of a talent identification process, namely talent identification process 400, in accordance with one embodiment of the present invention. As depicted in FIG. 4A, talent identification process 400 begins at step 402 with the start of the first phase of talent identification process 400, after which talent identification process 400 proceeds to step 404.

At step 404, a plurality of artists and/or bands is selected from existing unaffiliated talent competitions such as battle of the band competitions and various other talent competitions conducted worldwide or in one or more specific, predetermined geographic areas. In one aspect of the present invention, eligible artists and/or bands will consist of artists and/or bands who have reached the finals, semi-finals, or the like in one or more existing local, national, and/or international talent competitions. In some embodiments of the present invention, such artists and/or bands will be required to have an existing portfolio including one or more of artist and/or band biographies, original music, original music videos, professionally recorded songs, and the like. However, such a requirement is not necessary to implement the systems and methods of the present invention. Talent identification process 400 then proceeds to step 406.

At step 406, songs are received from the artists and/or bands selected in step 404. In one aspect of the present invention, such received songs are original works that have been created and performed by the respective artist(s) and/or band(s). However, alternate embodiments of the present invention are envisioned in which such received songs have been created by entities other than the advancing artist(s) and/or band(s). Or, such received songs may be songs originally performed by artist(s) and/or band(s) other than the advancing artist and/or band.

Next, at step 408, the songs received in step 406 are published to an Internet Web site. In one embodiment of the present invention, publishing includes uploading the information to a server or the like, which would typically be hosted by the entity implementing talent identification process 400. Thereafter, critics may access the published songs via a portal such as a Web page of the Internet Web site. Furthermore, the Web site may include a search engine configured to identify published songs via one or more criteria including, but not limited to, artist, band, one or more keywords, and title. In such an embodiment, published songs may be retrieved by entering relevant search criteria in the search engine. Upon executing the search, the song, as well as other information relating to the song and its associated artist and/or band, is made available to the critic for listening, downloading, and/or evaluation. Talent identification process 400 then proceeds to step 410.

At step 410, published songs have been made available to the critic for listening, downloading, and/or evaluation via an Internet Web page. At this point, such individual may listen to or download one or more songs. In some embodiments of the present invention, the user simply clicks a link corresponding to the song and the desired task (e.g., downloading, listening, etc.). In one aspect of the present invention, clicking such links may also redirect the individual to the respective artist's and/or band's Web site to allow the individual to gain additional information regarding the respective artist and/or band.

During step 410, feedback is received for each published song. In one embodiment of the present invention, critics vote for each song. In another embodiment of the present invention, a server or the like through which the songs have been published tallies the number of times each song is accessed by a critic. For example, such server may record the number of times each song is downloaded, listened to, or otherwise accessed. Such critique, feedback, or the like may be gathered or collected via any system and method known in the art or any systems and methods yet to be invented without departing from the scope of the present invention. Such systems and methods include, but are not limited to, Internet tracking, electronic mail, text messaging, servers, telephones, cell phones, Apple Ipods™, personal computers, and/or Blackberrys®.

Talent identification process 400 then proceeds to step 412. The first phase of talent identification process 400 will run for a predetermined period. If the time period for such phase has not expired, talent identification process 400 returns to step 410. However, if such time period has expired, talent identification process 400 proceeds to step 414.

At step 414, the feedback received for each song is tallied. In one aspect of the present invention, the songs receiving the highest number of votes from the critics will be selected to advance to the second phase of talent identification process 400. However, alternative methods of tallying feedback may be substituted without departing from the scope of the invention. For example, such tallying may include tallying the number of times each song is downloaded, listened to, or the like. Talent identification process 400 then proceeds to step 416.

At step 416, a plurality of artists and/or bands associated with the songs receiving the most favorable feedback are advanced to the second stage of talent identification process 400. Thereafter, or simultaneous with step 416, such process proceeds to step 418, at which a portion of the revenue collected via talent identification process 400 is donated to charity. Such revenue may include, but is not limited to, fees charged to the critics, advertising or other promotional revenue, sales of goods associated with talent identification process 400, and the like as discussed in greater detail above with respect to FIG. 1.

Next, at step 420, the second phase of talent identification process 400 begins and the process proceeds to step 422. At 422, songs are received from the artists and/or bands advanced from the first phase to the second phase in step 416. Next, at step 424, the received songs are broadcast via radio such as commercial radio, satellite radio, and the like. In some embodiments of the present invention, such songs shall be the same songs evaluated during other phases of talent identification process 400. However, alternate embodiments of the present invention are envisioned in which each advancing artist and/or band must submit new songs for evaluation in one or more of the phases following the first phase. Depending upon the specific embodiment of the present invention, the broadcast songs may be heard by the general public, private subscribers (e.g., satellite radio subscribers), or a combination thereof.

Talent identification process 400 may optionally proceed to step 426, or, alternatively, such step may be omitted. At step 426, songs from the existing “Super Groups”, existing “Super Artists”, or other lesser-known musicians are played in combination with the songs received from the advancing artists and/or bands to provide perspective to the listeners and/or critics and to attract a larger audience of listeners. Talent identification process then proceeds to step 428.

During step 428, feedback is received for each broadcast song. In one embodiment of the present invention, critics vote for each song. Such critique, feedback, or the like may be provided via any system and method known in the art or any systems and methods yet to be invented without departing from the scope of the present invention. Such systems and methods include, but are not limited to, Internet tracking, electronic mail, text messaging, servers, telephones, cell phones, Apple Ipods™, personal computers, and/or Blackberrys®.

Talent identification process 400 then proceeds to step 430. The second phase of talent identification process 400 will run for a predetermined period. If the time period for such phase has not expired, talent identification process 400 returns to step 428. However, if such time period has expired, talent identification process 400 proceeds to step 432.

At step 432, the feedback received for each broadcast song is tallied. In one aspect of the present invention, the songs receiving the highest number of votes from the critics will be selected to advance to the third phase of talent identification process 400. However, alternative methods of tallying feedback may be substituted without departing from the scope of the invention. Talent identification process 400 then proceeds to step 434.

At step 434, a plurality of artists and/or bands associated with the songs receiving the most favorable feedback are advanced to the third stage of talent identification process 400. Thereafter, such process proceeds to step 436, at which a portion of the revenue collected via talent identification process 400 is donated to charity. Such revenue may include, but is not limited to, fees charged to the critics, advertising or other promotional revenue, sales of goods associated with talent identification process 400, and the like as discussed in greater detail above with respect to FIG. 1.

Next, at step 438, the third phase of talent identification process 400 begins and the process proceeds to step 440. At step 440, artists and/or bands advanced from the second phase to the third phase are received. Next, at step 442, the received artists and/or bands will compete in a local, national, or international television competition. In some embodiments of the present invention, such artists and/or bands shall perform the same song or songs evaluated during earlier phases of talent identification process 400. However, alternate embodiments of the present invention are envisioned in which each advancing artist and/or band must perform a new song for evaluation in the third phase of talent identification process 400.

Next, at step 444, the television competition is broadcast to the entire participating geographic area of talent identification process 400 (e.g., worldwide) allows critics within such geographic area to see, hear, and evaluate such artists and/or bands and the associated performances. Such television competition may also be simulcast on the Internet, radio, or the like. Step 444 may occur simultaneously with step 442 (i.e., a live television competition) or subsequent to step 442 (i.e., broadcast of a taped television performance). Talent identification process then proceeds to step 446.

During step 446, feedback is received for each artist and/or band performing in the television competition. In one embodiment of the present invention, critics vote for each song. Such critique, feedback, or the like may be provided via any system and method known in the art or any systems and methods yet to be invented without departing from the scope of the present invention. Such systems and methods include, but are not limited to, Internet tracking, electronic mail, text messaging, servers, telephones, cell phones, Apple Ipods™, personal computers, and/or Blackberrys®.

Talent identification process 400 then proceeds to step 448. The third phase of talent identification process 400 will run for a predetermined period. If the time period for such phase has not expired, talent identification process 400 returns to step 446. However, if such time period has expired, talent identification process 400 proceeds to step 450.

At step 450, the feedback received for each performing artist and/or band is tallied. In one aspect of the present invention, the artist and/or band receiving the highest number of votes from the critics will be selected as the winner of talent identification process 400. However, alternative methods of tallying feedback may be substituted without departing from the scope of the invention. Talent identification process 400 then proceeds to step 452.

At step 452, a determination is made regarding which artist and/or band received the most favorable feedback. Thereafter, talent identification process 400 proceeds to step 454, at which the winning artist and/or band is rewarded. In the embodiment of the present invention depicted in FIGS. 4A-4C, the winning artist and/or band is awarded with a record deal. However, other awards may be substituted without departing from the scope of the present invention.

Next, at step 456, a portion of the revenue collected via talent identification process 400 is donated to charity. Such revenue may include, but is not limited to, fees charged to the critics, advertising or other promotional revenue, sales of goods associated with talent identification process 400, and the like as discussed in greater detail above with respect to FIG. 1. Thereafter, talent identification process 400 ends at step 458.

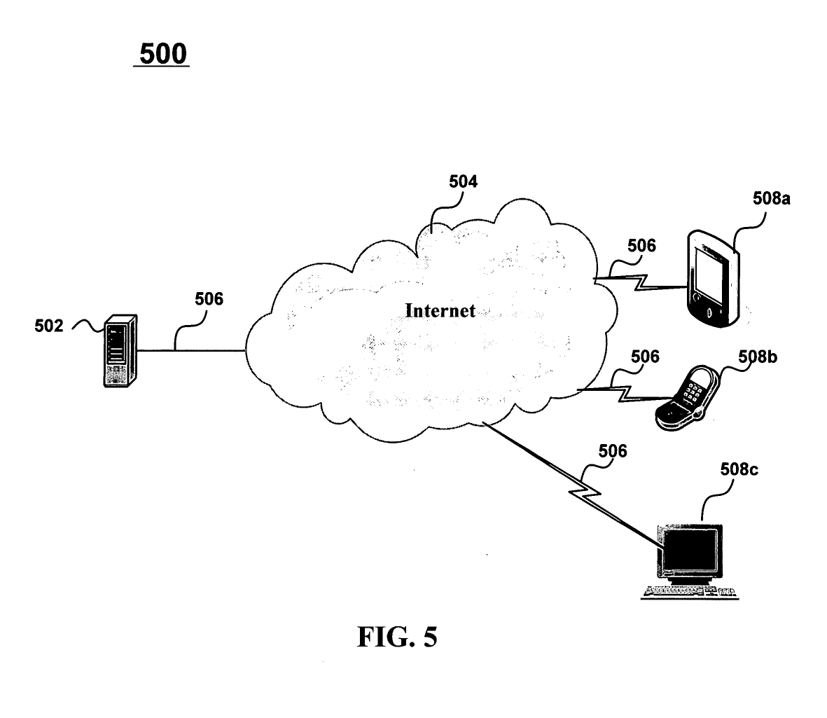

Turning now to FIG. 5, illustrated is a schematic diagram of an exemplary computer environment 500 for receiving critique, feedback, and the like in accordance with an embodiment of the present invention. In the depicted embodiment, computer environment 500 includes, inter alia, data system 502, Internet 504, connections 506, and computing devices 508a, 508b, and 508c.

Computing devices 508a, 508b, and 508c are connected to Internet 504 via connections 506, which may be any form of Internet connection known in the art or yet to be invented. Connections 506 may include, but are not limited to, telephone lines (xDSL, T1, leased lines, etc.), cable lines, power lines, wireless transmissions, and the like. Computing devices 508a, 508b, and 508c include any equipment necessary (e.g., modems, routers, etc.), as is known in the art, to facilitate such communication with the Internet. Data system 502 is also connected to Internet 504 using one of the aforementioned methods or other such methods known in the art.

Using a system such as that depicted in FIG. 3, a critic may vote for an artist and/or band via a computing device connected to Internet 504 such as computing device 508a, 508b, and 508c. Such a computing device may be the individual's personal computer, an Internet café computer, an Apple Ipod™, a computerized portable electronic device (e.g., a personal data assistant, cell phone, etc.), or the like. Using the system exemplified in FIG. 5, such voting may include upload of an electronic form of the information from a computing device 508a, 508b, and 508c via Internet 504 to data system 502 (e.g., server, mainframe, computer, etc.), wherein data system 502 is typically provided and/or managed by the entity implementing the talent identification process or its affiliate, subcontractor, or the like. However, alternate embodiments of collecting votes may be substituted without departing from the scope hereof. For example, in one aspect of the present invention, the voter transmits the vote directly to the entity implementing the talent identification process in electronic format without upload (e.g., via electronic mail). Such transmission may also be performed at a computing device 508a, 508b, or 508c via Internet 504, however, in this scenario, manipulation by the entity's staff or systems may be required prior to transferring the voting information to data system 502.

Although the systems and methods disclosed herein have focused on embodiments in which musical talent is discovered, one of skill in the art may easily appreciate that such systems and methods may be equally applied for identification of other types of non-musical talent such as models, athletes, actors/actresses, and the like.

Although several processes have been disclosed herein as software, it may be appreciated by one of skill in the art that the same processes, functions, etc. may be performed via hardware or a combination of hardware and software. Similarly, although the present invention has been depicted as a hardwired system, these concepts may be applied to wireless systems and hybrid hardwired and wireless systems without departing from the scope of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-2. (canceled)

3. A method of identifying talent comprising:
receiving talent;
receiving talent media from said talent;
making at least one of the group consisting of said talent, said talent media, and combinations thereof available to a public via a first medium;
receiving first feedback from said public;
selecting a first portion of said talent, said talent media, and combinations thereof based upon said first feedback;
making at least one of the group consisting of said first portion of said talent, said talent media, and combinations thereof available to the public via a second medium;
receiving second feedback from said public;
selecting a second portion of said first portion of said talent, said talent media, and combinations thereof based upon said second feedback;
making at least one of the group consisting of said second portion of said talent, said talent media, and combinations thereof available to the public via a third medium;
receiving third feedback from said public; and
selecting at least one top performer from said second portion based upon said third feedback.

4. A method according to claim 3, wherein said talent is received from at least one competition not affiliated with a user of said method.

5. A method according to claim 3, wherein said at least one competition not affiliated with a user of said method is at least one of the group consisting of local talent competitions, state talent competitions, regional talent competitions, country talent competitions, battle-of-the-band competitions, and combinations thereof.

6. A method according to claim 4, wherein said at least one competition not affiliated with a user of said method is performed via at least one of the group consisting of Internet, radio, television, and combinations thereof.

7. A method according to claim 3, wherein at least one of the group consisting of said selecting said first portion, selecting said second portion, selecting said top performer, and combinations thereof includes at least one of the group consisting of tallying votes, tallying downloaded songs, tallying downloaded videos, tallying accessed songs, tallying accessed videos, and combinations thereof.

8. A method according to claim 3,
wherein said feedback is provided via at least one electronic device; and
wherein said electronic device is at least one of the group consisting of a personal computer, a telephone, a cell phone, an IPod™, a personal data assistant, and combinations thereof.

9. A method according to claim 3, wherein said feedback is at least one of the group consisting of an electronic mail message, a text message, a vote, and combinations thereof.

10. A method according to claim 3, wherein at least one of said at least one top performer receives at least one reward.

11. A method according to claim 10, wherein at least one of said at least one reward is a recording contract.

12. A method according to claim 3, wherein each of the group consisting of said first medium, said second medium, said third medium, and combinations thereof is selected from the group consisting of Internet, radio, television, and combinations thereof.

13. A method according to claim 12, wherein said radio includes at least one of the group consisting of commercial radio, satellite radio, and combinations thereof.

14. A method according to claim 3, wherein said first medium is Internet, said second medium is radio, and said third medium is television.

15. A method according to claim 3 further comprising:
generating revenue from at least one of the group consisting of fees for providing feedback, downloading fees, access fees, advertising fees, sponsor fees, promotional item sales, music sales, video sales, and combinations thereof.

16. A method according to claim 15, wherein at least a portion of said revenue is donated to charity.

17. A method according to claim 3, wherein said talent is at least one of the group consisting of individual artists, bands, and combinations thereof.

18. A method according to claim 3, wherein said talent media is at least one of the group consisting of songs, videos, and combinations thereof.

19. A method according to claim 3, wherein said at least one of the group consisting of said talent, said talent media, said first portion, said second portion, and combinations thereof is segmented.

20. A method according to claim 19, wherein said segmenting is performed based upon at least one of the group consisting of geography, music genre, age of said talent, number of artists in said talent, name of said talent, name of said media, dates, and combinations thereof.

21. A method according to claim 3, wherein at least a portion of said feedback is segmented.

22. A method according to claim 3 further comprising:
collecting demographic information regarding said public.

23. A method according to claim 3, wherein said talent media is made available to the public in combination with well-known media generated by famous musicians.

24. A method according to claim 3, wherein at least one of the group consisting of said first medium, said second medium, said third medium, and combinations thereof is at least one of the group consisting of a new radio station, a dedicated radio station, and combinations thereof.

25. A method according to claim 3 further comprising:
selecting at least one top feedback provider based upon said feedback.

26. A method according to claim 25, wherein said top feedback provider is rewarded with a reward.

27. A method according to claim 26, wherein said reward is at least one of the group consisting of a talent scout employment contract, a hosting employment contract, and combinations thereof.
